(19) United States
(12) Patent Application Publication
(10) Pub. No.: US 2025/0371135 A1
(43) Pub. Date: Dec. 4, 2025

(54) AGILE NETWORK SESSION MONITORING AND ENFORCEMENT

(71) Applicant: CyberArk Software Ltd., Petach-Tikva (IL)

(72) Inventors: Asaf Hecht, Petach-Tikva (IL); Michael Balber, Petach-Tikva (IL); Daniel Alfasi, Petach-Tikva (IL)

(73) Assignee: CyberArk Software Ltd., Petach-Tikva (IL)

(21) Appl. No.: 18/677,503

(22) Filed: May 29, 2024

(51) Int. Cl. G06F 21/55; G06F 40/30

(52) U.S. Cl. CPC G06F 21/55; G06F 40/30

(57) ABSTRACT

Disclosed embodiments relate to systems and methods for dynamically reviewing managed session activity using machine learning models. Techniques include identifying a managed session between a network identity and a target resource; performing a reviewal process for the managed session, including identifying session data associated with the managed session; providing the session data and a context data as an input to at least one machine learning model; obtaining an output from the at least one machine learning model based on an analysis of the session data and the context data; and determining, based on the output, whether to perform a security action associated with the managed session.

### BACKGROUND

### Technical Field

The present disclosure relates generally to cybersecurity and, more specifically, to techniques for secure provision of secrets for dynamically reviewing managed session activity to identify security risks.

### Background Information

As cybersecurity is an ever-growing concern, it is increasingly important for organizations and individuals alike to monitor activity of users within a network environment. Cybersecurity attacks may involve attackers compromising accounts of network users and accessing their credentials and network permissions. This may provide these attackers with access to the network's sensitive information and in turn enable the attackers to exfiltrate such information or compromise sensitive systems within the network.

Some techniques to mitigate the risk of these attacks may include implementing session management tools, providing real-time session monitoring, or performing audits of previous session recordings. These approaches, however, may require manually monitoring the sessions and their recordings, which can be difficult and time-consuming. For an organization, for example, this may require monitoring sessions simultaneously, and thus monitoring and enforcing such sessions by human employees is difficult, if not impossible.

Other techniques involve the use of hard coded rules to monitor for suspicious commands. These techniques may also be very limited as hard coded rules do not take into consideration the context of various commands. What may be suspicious in some contexts may be perfectly normal in other contexts. Accordingly, it can be difficult or impossible to design rules capable of accurately capturing suspicious activity, which may lead to high rates of false positive alerts, which can be costly and time consuming to manage. Further, implementing static rules may allow attackers to identify gaps in these rules to bypass the security measures undetected.

Accordingly, in view of these and other deficiencies in such techniques, technological solutions are needed for dynamically monitoring activity within a monitored session, either in real-time or in recorded session data. Solutions should advantageously account for context data, which may provide important insights as to which activities are potentially malicious. Solutions should also incorporate machine learning models, which may allow the system to detect simple to intricate patterns of behavior represented in vast amounts of data, which a human observer may otherwise miss. These and other techniques are discussed below, providing significant technological improvements in the areas of security, efficiency, and useability.

### SUMMARY

The disclosed embodiments describe non-transitory computer readable media, systems, and methods for analyzing session activity. For example, in an embodiment, a non-transitory computer readable medium may include instructions that, when executed by at least one processor, cause the at least one processor to perform operations for dynamically reviewing managed session activity using machine learning models. The operations may comprise identifying a managed session between a network identity and a target resource; performing a reviewal process for the managed session, the reviewal process comprising identifying session data associated with the managed session; providing the session data and a context data as an input to at least one machine learning model, the at least one machine learning model comprising at least one large language model, wherein the context data includes data clustered from a plurality of data sources associated with the network identity; obtaining an output from the at least one machine learning model, the output being based on an analysis of the session data and the context data; and determining, based on the output, whether to perform a security action associated with the managed session.

According to a disclosed embodiment, the output from the at least one machine learning model may include at least one indication of malicious intent by the network identity that is not associated with a rule-based security policy.

According to a disclosed embodiment, the operations may further include receiving the context data as an output of an additional machine learning model, the additional machine learning model having been pre-trained on data associated with the network identity.

According to a disclosed embodiment, the context data may include at least one of: historical managed session data, metadata associated with the identity, sensor data associated with the identity, or synthetic managed session data.

According to a disclosed embodiment, the historical managed session data may be associated with at least one of the identity or identities determined to be related or similar to the identity.

According to a disclosed embodiment, the reviewal process may include intercepting at least a portion of the session data during the managed session.

According to a disclosed embodiment, the session data may be preprocessed to identify a relevancy of at least a portion of the session data.

According to a disclosed embodiment, the preprocessing may include providing the session data to at least one additional machine learning model having been pretrained to determine the relevancy of session data.

According to a disclosed embodiment, the at least one additional machine learning model may be pretrained to determine the relevancy of session data based on an active window associated with the managed session.

According to a disclosed embodiment, an output of the at least one additional machine learning model may include a selected subset of the session data.

According to a disclosed embodiment, the determination whether to perform the security action may occur during a current timeframe and the session data includes session data recorded during a previous timeframe prior to the current timeframe.

According to a disclosed embodiment, the reviewal may be performed by an agent running at a machine used by the identity.

According to a disclosed embodiment, providing the session data as an input to at least one machine learning model may include translating the session data to semantic data. The session data may include a video of the managed session and the semantic data may include text extracted from the video.

According to a disclosed embodiment, determining whether to perform the security action associated with the managed session may further be based on feedback from at least one of the network identity or the target resource.

According to a disclosed embodiment, the feedback may include at least one of: data provided by the network identity, data associated with an action performed on the target resource by the network identity, a previous determination of whether to perform the security action, or the content of the security action.

According to a disclosed embodiment, providing the session data and the context data as an input to at least one machine learning model may include generating a prompt for the large language model, the prompt including the session data and the context data.

According to a disclosed embodiment, the security action may include at least one of: generating an alert for the managed session or generating a report for the managed session.

According to a disclosed embodiment, the security action may include at least one of: pausing or terminating the managed session.

According to a disclosed embodiment, the security action may include at least one of: requiring an authentication associated with the managed session, managing a secret associated with at least one of the network identity or the target resource, or managing a policy associated with at least one of the network identity or the target resource.

According to another disclosed embodiment, there may be a computer-implemented method for dynamically reviewing managed session activity using machine learning models. The method may comprise identifying a managed session between a network identity and a target resource; performing a reviewal process for the managed session, the reviewal process comprising identifying session data associated with the managed session; providing the session data and a context data as an input to at least one machine learning model, the at least one machine learning model comprising at least one large language model, wherein the context data includes data clustered from a plurality of data sources associated with the network identity; obtaining an output from the at least one machine learning model, the output being based on an analysis of the session data and the context data; and determining, based on the output, whether to perform a security action associated with the managed session.

According to a disclosed embodiment, the method may further comprise determining, based on the output from the at least one machine learning model, an intended network action associated with the network identity.

According to a disclosed embodiment, the intended network action may comprise at least one of: a command or a behavior.

According to a disclosed embodiment, the method may further comprise determining, based on the output from the at least one machine learning model, whether the monitored session deviates from the intended network action.

According to a disclosed embodiment, the method may further comprise determining, based on the output from the at least one machine learning model, whether the monitored session deviates from the intended network action.

According to a disclosed embodiment, the method may further comprise performing the security action when the monitored session deviates from the intended network action.

According to a disclosed embodiment, the method may further comprise determining, based on the output from the at least one machine learning model, whether the monitored session includes an activity from a plurality of predefined suspicious network activities.

According to a disclosed embodiment, the plurality of predefined suspicious network activities may be determined based on at least one previous output from the at least one machine learning model.

According to a disclosed embodiment, the method may further comprise performing the security action when the monitored session includes the activity from the set of suspicious network activities.

Aspects of the disclosed embodiments may include tangible computer-readable media that store software instructions that, when executed by one or more processors, are configured for and capable of performing and executing one or more of the methods, operations, and the like consistent with the disclosed embodiments. Also, aspects of the disclosed embodiments may be performed by one or more processors that are configured as special-purpose processor(s) based on software instructions that are programmed with logic and instructions that perform, when executed, one or more operations consistent with the disclosed embodiments.

It is to be understood that both the foregoing general description and the following detailed description are exemplary and explanatory only, and are not restrictive of the disclosed embodiments, as claimed.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 is a block diagram illustrating an example system environment for analyzing managed session activity, consistent with the disclosed embodiments.

FIG. 2A is a block diagram showing an example server, consistent with the disclosed embodiments.

FIG. 2B is a block diagram showing an example computing device, consistent with the disclosed embodiments.

FIG. 3A is a block diagram showing an example process for dynamically reviewing managed session activity, consistent with the disclosed embodiments.

FIG. 3B is a block diagram showing another example process for dynamically reviewing managed session activity, consistent with the disclosed embodiments.

FIG. 4A is a block diagram showing an example process for generating a prompt 400 to input to trained model, consistent with the disclosed embodiments.

FIG. 4B is a block diagram showing an example process for generating semantic data using a trained model, consistent with the disclosed embodiments.

FIG. 5 is an illustration of an example image from which semantic information may be extracted, consistent with the disclosed embodiments.

FIG. 6 is a flowchart showing an example process for dynamically reviewing managed session activity using machine learning models, consistent with the disclosed embodiments.

### DETAILED DESCRIPTION

In the following detailed description, numerous specific details are set forth in order to provide a thorough understanding of the disclosed example embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence, or constrained to a particular system configuration. Additionally, some of the described embodiments or elements thereof can occur or be performed simultaneously, at the same point in time, or concurrently.

The techniques for securely providing secrets described herein overcome several technological problems relating to security, efficiency, and performance in the fields of cybersecurity and network security. As discussed above, attackers may infiltrate a network by assuming an identity of a network user. It may be difficult, if not impossible, to distinguish the activity of this attacker and the normal activity of the user, especially before it is too late. To address these forms of security risks, the disclosed techniques may dynamically monitor session activity using a trained machine learning model. For example, many generative AI technologies like ChatGPT™, Bard™, Claude™, and others offer tools for analyzing multimodal signals, including text, audio, image and video, that may or may not be integrated into semantic communication. By leveraging these or other forms of AI tools, the disclosed techniques may automatically detect or predict malicious activity, as or even before it occurs.

Consistent with the disclosed embodiments, various session data may be accessed from a managed session. In some embodiments, this session data may be translated to sematic data, which may be more easily digested by a machine learning model, such as a large language model (LLM). Alternatively or additionally, the session data may be provided directly to the LLM without first being translated to semantic data. The model may be trained to identify indications of malicious activity in this session data. In some embodiments, the model may also receive context data as an input, which may improve the detection of malicious activity. For example, certain activities may seem malicious in some contexts, but may be benign in other contexts. Accordingly, the model may leverage this context data in identifying malicious activity. The disclosed techniques thus provide significant improvements over the other techniques described above.

Reference will now be made in detail to the disclosed embodiments, examples of which are illustrated in the accompanying drawings.

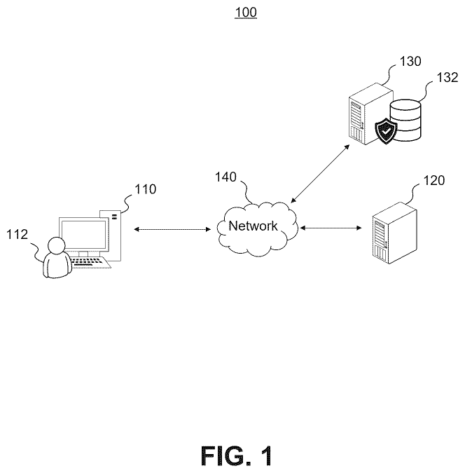

FIG. 1 illustrates an example system environment 100 for analyzing managed session activity, consistent with the disclosed embodiments. System environment 100 may include one or more computing devices 110, one or more target resources 120, and one or more security servers 130, as shown in FIG. 1. System environment 100 may represent a system or network environment in which a managed session may be established between a network identity and a target resource. As used herein, a managed session may refer to any session during which interactions between a user or other identity can be monitored and managed. For example, a managed session may include, but is not limited to, a Remote Desktop Protocol (RDP) session with a target Windows™ machine, a secure shell (SSH) connection for Linux servers, a monitored and secured web session, a connection to a database, a Kubernetes, a cloud providers, or any other form of session through which data may be exchanged between entities. In the example of system environment 100, a managed session may be established between computing device 110 (or an entity associated with computing device 110, such as identity 112) and target resource 120.

In some embodiments, a managed session may include a network-based session. For example, this may include an operation performed using computing device 110 involving a file or other data on target resource 120. Alternatively, some or all of the managed session activity may occur locally. For example, the local computing operation may be an operation involving a file stored in computing device 110. Accordingly, while system environment 100 is shown in FIG. 1 to include target resource 120 and security server 130 separately from computing device 110 by way of example, in some embodiments, one or both of target resource 120 and security server 130 may be integrated with computing device 110. For example, target resource 120 may be a local resource of computing device 110 and security server 130 may be an agent or other process running on computing device 110. Accordingly, system environment 100 may not necessarily be a network-based system environment and may be a local environment of computing device 110.

The various components of system environment 100 may communicate over a network 140. Such communications may take place across various types of networks, such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth™, infrared, etc.), or various other types of network communications. In some embodiments, the communications may take place across two or more of these forms of networks and protocols. While system environment 100 is shown as a network-based environment, it is understood that in some embodiments, one or more aspects of the disclosed systems and methods may also be used in a localized system, with one or more of the components communicating directly with each other.

As noted above, system environment 100 may include one or more computing devices 110. Computing device 110 may include any device that may be used for engaging in a managed session. Accordingly, computing device 110 may include various forms of computer-based devices, such as a workstation or personal computer (e.g., a desktop or laptop computer), a mobile device (e.g., a mobile phone or tablet), a wearable device (e.g., a smart watch, smart jewelry, implantable device, fitness tracker, smart clothing, head-mounted display, etc.), an IoT device (e.g., smart home devices, industrial devices, etc.), or any other device that may be capable of performing a privileged computing operation. In some embodiments, computing device 110 may be a virtual machine (e.g., based on AWS™, Azure™, IBM Cloud™, etc.), container instance (e.g., Docker™ container, Java™ container, Windows Server™ container, etc.), or other virtualized instance.

In some embodiments, computing device 110 may be associated with an identity 112. Identity 112 may be any entity that may be associated with one or more privileges to be asserted to perform a privileged computing operation. For example, identity 112 may be a user, an account, an application, a process, an operating system, a service, an electronic signature, or any other entity or attribute associated with one or more components of system environment 100. In some embodiments, identity 112 may be a user requesting to perform various operations through a managed session, which may include accessing data stored in target resource 120.

Target resource 120 may include any form of computing device with which a managed session may be established. Examples of target resource 120 may include SQL servers, databases or data structures holding confidential information, restricted-use applications, operating system directory services, access-restricted cloud-computing resources (e.g., an AWS™ or Azure™ server), sensitive IoT equipment (e.g., physical access control devices, video surveillance equipment, etc.) and/or any other computer-based equipment or software that may be accessible over a network. Target resource 120 may include various other forms of computing devices, such as a mobile device (e.g., a mobile phone or tablet), a wearable device (a smart watch, smart jewelry, implantable device, fitness tracker, smart clothing, or head-mounted display, etc.), an IoT device (e.g., a network-connected appliance, vehicle, lighting, thermostat, room access controller, building entry controller, parking garage controller, sensor device, etc.), a gateway, switch, router, portable device, virtual machine, or any other device that may be subject to privileged computing operations. In some embodiments, target resource 120 may be a privileged resource, such that access to the network resource 120 may be limited or restricted. For example, access to the target resource 120 may require a secret (e.g., a password, a username, an SSH key, an asymmetric key, a symmetric key, a security or access token, a hash value, biometric data, personal data, etc.). In some embodiments target resource 120 may not necessarily be a separate device from computing device 110 and may be a local resource. Accordingly, target resource 120 may be a local hard drive, database, data structure, or other resource integrated with computing device 110.

Security server 130 may be configured to monitor and/or manage one or more sessions within system environment 100. For example, security server 130 may review activity between computing device 110 and target resource 120. In some embodiments, security server 130 may further be configured to manage one or more privileges associated with system environment 100. For example, security server 130 may be configured to grant, track, monitor, store, revoke, validate, or otherwise manage privileges of various identities within system environment 100. While illustrated as a separate component of system environment 100, it is to be understood that security server 130 may be integrated with one or more other components of system environment 100. For example, in some embodiments, security server 130 may be implemented as part of target network resource 120, computing device 110, or another device of system environment 100.

In some embodiments, security server 130 may be configured to review session activity real-time. For example, this may include monitoring session activity as it occurs to identify potential security threats. Alternatively or additionally, security server 130 may be configured to review recorded activity session data from a managed session. Accordingly security server 130 may be configured to record various actions within system environment 100 and/or access recorded session activity. In some embodiments, server 130 may implement a machine learning model, such as a large language model (LLM) or other transformer model, to perform various aspects of the reviewal process.

In some embodiments, security server 130 may be configured to predict a need for a secret (e.g., a privileged credential) and provide them proactively, as described in further detail below. For example, security server 130 may identify trigger information within system environment 100 indicating computing device 110 (or one or more services executing on or in association with computing device (or devices) 110) may begin performing an action or series of actions requiring or involving a secret. Accordingly, security server 130 may anticipate the need for the secret and provide it proactively. As described above, this may improve security and efficiency within system environment 100.

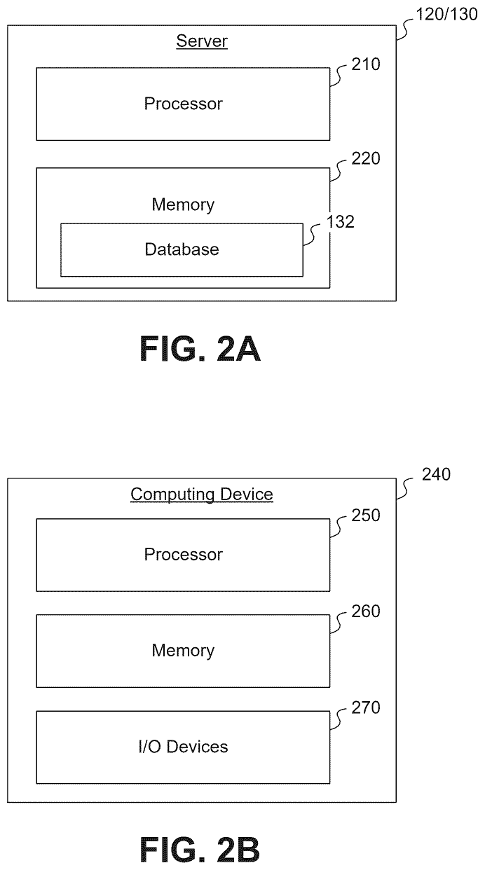

FIG. 2A is a block diagram showing an example server, consistent with the disclosed embodiments. For example, the server shown in FIG. 2A may correspond to one or both of security server 130 and target resource 120. As shown in FIG. 2A, privilege management server 200 (e.g., similar to server 130) may include a processor (or multiple processors) 230, a memory (or multiple memories) 240, and/or one or more input/output (I/O) devices (not shown), as shown in FIG. 2A.

Processor 210 may take the form of, but is not limited to, a microprocessor, embedded processor, or the like, or may be integrated in a system on a chip (SoC). Furthermore, according to some embodiments, processor 210 may be from the family of processors manufactured by Intel®, AMD®, Qualcomm®, Apple®, NVIDIA®, or the like. The processor 210 may also be based on the ARM architecture, a mobile processor, or a graphics processing unit, etc. The disclosed embodiments are not limited to any type of processor configured in security server 130 or target resource 120.

Memory 220 may include one or more storage devices configured to store instructions used by the processor 210 to perform functions related to computing device 110. The disclosed embodiments are not limited to particular software programs or devices configured to perform dedicated tasks. For example, memory 220 may store a single program, such as a user-level application, that performs the functions associated with the disclosed embodiments, or may comprise multiple software programs. Additionally, processor 210 may, in some embodiments, execute one or more programs (or portions thereof) remotely located from security server 130 or target resource 120. Furthermore, memory 220 may include one or more storage devices configured to store data for use by the programs. Memory 220 may include, but is not limited to a hard drive, a solid state drive, a CD-ROM drive, a peripheral storage device (e.g., an external hard drive, a USB drive, etc.), a network drive, a cloud storage device, or any other storage device.

In some embodiments, memory 220 may include a database 132 as described above. Database 132 may be included on a volatile or non-volatile, magnetic, semiconductor, tape, optical, removable, non-removable, or other type of storage device or tangible or non-transitory computer-readable medium. Database 132 may also be part of security server 130 (or target resource 120) or may be accessed remotely. When database 132 is not part of security server 130, security server 130 may exchange data with database 132 via a communication link. Database 132 may include one or more memory devices that store data and instructions used to perform one or more features of the disclosed embodiments. Database 132 may include any suitable databases, ranging from small databases hosted on a work station to large databases distributed among data centers. Database 132 may also include any combination of one or more databases controlled by memory controller devices (e.g., server(s), etc.) or software. For example, database 132 may include document management systems, Microsoft SQL™ databases, SharePoint™ databases, Oracle™ databases, Sybase™ databases, other relational databases, or non-relational databases, such as mongo and others.

FIG. 2B is a block diagram showing an example computing device 110, consistent with the disclosed embodiments. Computing device 110 may include one or more dedicated processors and/or memories. For example, server 130 may include a processor (or multiple processors) 250, and a memory (or multiple memories) 260, and one or more input or output devices (“I/O” devices) 270 as shown in FIG. 2B.

As with processor 210, processor 250 may take the form of, but is not limited to, a microprocessor, embedded processor, or the like, or may be integrated in a system on a chip (SoC). Furthermore, according to some embodiments, processor 250 may be from the family of processors manufactured by Intel®, AMD®, Qualcomm®, Apple®, NVIDIA®, or the like. Processor 250 may also be based on the ARM architecture, a mobile processor, or a graphics processing unit, etc. The disclosed embodiments are not limited to any type of processor configured in computing device 110.

Further, similar to memory 220, memory 260 may include one or more storage devices configured to store instructions used by the processor 250 to perform functions related to security server 130/200. The disclosed embodiments are not limited to particular software programs or devices configured to perform dedicated tasks. For example, memory 260 may store a single program, such as a user-level application (e.g., a browser), that performs the functions associated with the disclosed embodiments, or may comprise multiple software programs. Additionally, processor 250 may, in some embodiments, execute one or more programs (or portions thereof) remotely located from security server 130 (e.g., located on server 130/200). Furthermore, memory 260 may include one or more storage devices configured to store data for use by the programs. Memory 260 may include, but is not limited to a hard drive, a solid state drive, a CD-ROM drive, a peripheral storage device (e.g., an external hard drive, a USB drive, etc.), a network drive, a cloud storage device, or any other storage device.

Computing device 110 may further include one or more input/output (I/O) devices 270. I/O devices 270 may include one or more network adaptors or communication devices and/or interfaces (e.g., WiFi, Bluetooth®, RFID, NFC, RF, infrared, Ethernet, etc.) to communicate with other machines and devices, such as with other components of system environment 100 through network 140. For example, computing device 110 may use a network adaptor to access various resources in system environment 100. In some embodiments, the I/O devices 270 may also comprise a touchscreen configured to allow a user to interact with computing device 110 and/or an associated computing device. The I/O device 270 may comprise a keyboard, mouse, trackball, touch pad, stylus, and the like.

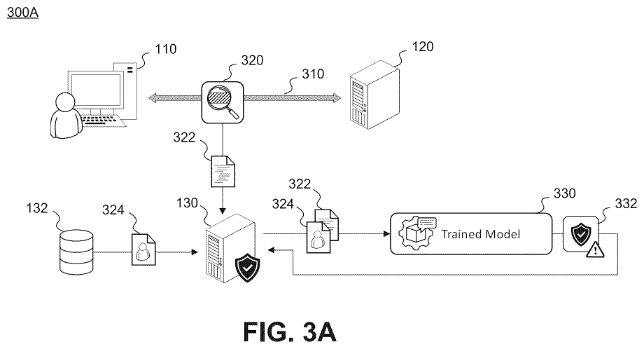

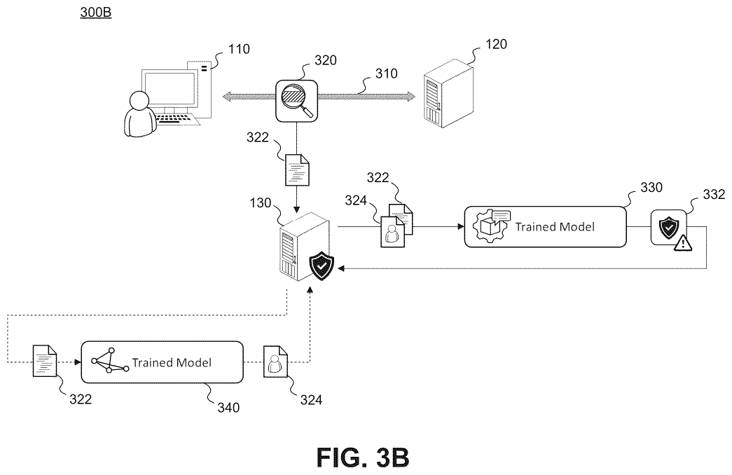

FIG. 3A is a block diagram showing an example process 300A for dynamically reviewing managed session activity, consistent with the disclosed embodiments. As discussed above, security server 130 may be configured to manage sessions between various entities within system environment 100. For example, a managed session 310 may be established between computing device 110 and network resource, as shown in FIG. 3A. Security server 130 may be configured to perform a reviewal process 320 for managed session 310. In some embodiments, reviewal process 320 may include monitoring live session activity within managed session 310 as it occurs (e.g., in real-time or near-real-time). Alternatively or additionally, reviewal process 320 may include analyzing previously recorded session activity within managed session 310. In some embodiments, the previously recorded session activity may be recorded by security server 130. For example, security server 130 may commence recording by a user clicking a mouse (e.g., left click, right click, or additional buttons), moving a mouse, hovering a mouse, touching a display screen, pressing a key on a keyboard, scrolling on a webpage, zooming in or out on a webpage, opening a new browser tab, closing a browser tab, switching to another browser tab, refreshing a webpage, navigating forward or back through the browser, resizing a browser window, navigating to another URL or web page, bookmarking a webpage, performing a copy or paste action, highlighting text or other elements of a webpage, or any other interactions by a user with a webpage, browser, or endpoint device or various other data during managed session 310. Alternatively or additionally, the previously recorded session activity may be recorded by another entity and accessed by security server 130.

Consistent with the disclosed embodiments, reviewal process 320 may include identifying session data associated with managed session 310. The session data may include any form of data gathered during a managed session. For example, as indicated above, session data may include logs of commands, image and video recordings of on-screen behavior, keystroke and mouse movements logs, file access, network activity, database queries, applications that are used, executed scripts, or any other form of data that may be collected during managed session 310. In some embodiments, system environment 100 may include various “sensors” for performing reviewal process 320. For example, a session sensor may include a proxy system deployed between computing device 110 and target resource 120, a client-side agent (such as a browser extension, or the like) operating on computing device 110, a network sniffer configured to monitor data flowing in network 140, a firewall, a routers, or any other component that may be have access to data associated with managed session 310.

In some embodiments, the session data may be translatable to semantic data, such as semantic data 322. As used herein, semantic data may refer to any data represented in a format such that it may be input to a particular form of trained model, such as an LLM or other transformer model. In some embodiments, semantic data may refer to data represented in alphanumeric symbols, such as text and numerical data. For example, a LLM may be configured to process data in the form of text-based prompts to provide contextual answers to the prompts. However, the various embodiments described herein are not limited to any particular format of semantic data.

In some embodiments, process 300A may include translating session data into semantic data 322. In some embodiments, the session data may be processed according to its source and destination. For example, graphical image data such as video recordings may be broken into single frames and text may be extracted from the frames (e.g., using Computer Vision (CV), Signal Processing, Object Character Recognition (OCR), or various other text extraction techniques). In some embodiments, commands and actions may be also recorded, logged and stored in a dedicated database. Metadata, such as time, date, location, IP addresses, or other forms of data may be collected and stored in association with semantic data 322. Alternatively or additionally, semantic data 322 may be translated by another resource and process 300A may include accessing the translated data. While the various examples provided herein generally describe translating session data to semantic data before inputting it into an LLM, in some embodiments, the session data may be input directly to an LLM. Accordingly, some or all of the operations described herein with respect to semantic data 322 may equally apply to session data (e.g., session data 410, described below).

In some embodiments, security server 130 may further be configured to access context data 324, as shown in FIG. 3A. In this example, context data 324 may be accessed from a database, such as database 132. Context data 324 may include any form of data that may provide context to one or more activities performed during managed session 310. While certain activities reflected in semantic data 324 may indicate a security threat in some contexts, they may not represent a security threat in other contexts. Accordingly, context data 324 may provide clues as to whether semantic data 322 (or session data) represents a security threat.

In some embodiments, context data 324 may include historical managed session data, which may be similar to the session data (or semantic data 322) discussed above, but may be associated with a previous managed session. In some embodiments, the historical managed session data may be related to managed session 310. For example, the historical managed session data may be associated with identity 112. Accordingly, the historical managed session data may provide context as to historical behavior of identity 112, which may indicate whether the current behavior is abnormal. Alternatively or additionally, the historical managed session data may be associated with an identity determined to be similar to identity 112. For example, the historical managed session data may be associated with an identity having one or more characteristics in common with identity 112 (e.g., similar privileges, location, IP address, or various other attributes). As another example, the historical managed session data may share various characteristics with managed session 310, such as the same target resource, a similar time of day, a similar time of year, a similar location, or the like. In some embodiments, the historical managed session data may not be associated with system environment 100 but may be general historical data accessed from various databases, the internet, or other sources.

In some embodiments, context data 324 may include synthetic managed session data. The synthetic managed session data may be similar to or the same as historical managed session data, however, one or more elements of the data may be generated data. For example, this may include filling in gaps in historical managed session data with expected or known events. Alternatively or additionally, the synthetic managed session data may include a combination of historical managed session data associated with different identities or sources. For example, the synthetic managed session data may be generated by combining, replacing, averaging, summarizing, or otherwise manipulating historical data from multiple sources.

As another example, context data 324 may include metadata associated with the identity. For example, this may include information such as a location of identity 112, an IP address of identity 112, a name or identifier of computing device 110, timestamp information, a keystroke profile of identity 112, an image of identity 112, or any other information associated with identity 112 that may be identified. In some embodiments, the metadata may be associated with the session data. Alternatively or additionally, the metadata may be separate from the session data and may be collected separate from managed session 310. In some embodiments, context data 324 may include sensor data associated with the identity. For example, this may include a particular form of data that is recorded in association with identity 112. The sensor data may include keystroke data (or other behavioral data), image or video data, location data, biometric data, time data (e.g., login times, etc.), or the like.

Consistent with the disclosed embodiments, process 300A may include inputting semantic data 322 (or session data) and context data 324 into a machine learning model. For example, this may include trained model 330, as shown in FIG. 3A. In some embodiments, trained model 330 may be a large language model configured to perform natural language processing (NLP) tasks and generate text outputs. Trained model 330 may include a generalized or publicly available LLM, such as ChatGPT™, Gemini™, Llama™, Claude™, or the like. Alternatively or additionally, trained model 330 may be a dedicated model developed for monitoring applications. Accordingly, trained model 330 may have been trained using a large volume of text applicable to system environment 100.

In some embodiments, trained model 330 may be at least partially trained for performing functions associated with system environment 100. For example, trained model 330 may include a generalized or publicly available LLM, as described above, that has been fine-tuned for performing tasks for dynamically reviewing managed session activity. For example, this may include inputting additional domain-specific labeled training data into a preexisting LLM to fine-tune the model. Alternatively or additionally, trained model 330 may include a model trained without any use of a preexisting model. For example, this may include inputting training data into a machine learning algorithm as part of a training process. The training data may include semantic data (similar to semantic data 322) and/or context data and may have been labeled to indicate whether one or more security actions should be performed. As a result, trained model 330 may be developed to assess whether various security actions should be performed based on semantic data 322 and context data 324.

In some embodiments, trained model 330 may be continuously fed with audits and feedback from previous instances to improve its performance and validity by adding context from the various sensors. For example, various feedback loops may be implemented to feed data back to a model database for training and fine-tuning trained model 330. While a LLM is used by way of example, trained model 330 may include various other forms of machine learning models, such as a logistic regression, a linear regression, a random forest, a K-Nearest Neighbor (KNN) model, a K-Means model, a decision tree, a cox proportional hazards regression model, a Naïve Bayes model, a Support Vector Machines SVM) model, a gradient boosting algorithm, a deep learning model, or any other form of machine learning model or algorithm.

Based on semantic data 322 and context data 324, trained model 330 may be configured to generate an output 332, which may be indicative of whether a security threat is indicated in managed session 310. In some embodiments, output 332 may be a text-based output. For example, semantic data 322 (or session data) and context data 324 may be input along with a text-based prompt and output 332 may be configured to generate a response to the prompt. In some embodiments, output 332 may be an explanation of whether or not various aspects of semantic data 322 represent a security threat in view of the context indicated by context data 324. For example, output 332 may be a response such as: “The user [(e.g., identity 112)] appears to be attempting to escalate his or her privileges for accessing this resource. First, this user normally does not access this type of database using this computing device. Second, the resource being accessed stores administrator privileges that provide higher access rights than the user holds. Appropriate action is recommended.” Alternatively or additionally, output 332 may include more simplified answers such as “yes” or “no” to targeted questions, such as whether a particular image shows a login page, whether activity is abnormal, whether a security vulnerability exists, or the like. In some embodiments, the prompt may request a recommended security response. Accordingly, the security action may be based on a recommendation in output 332.

Based on output 332, security server 130 may be configured to perform one or more security actions. In some embodiments, the security action may include generating an alert or report for the managed session. As another example, the security action may include controlling the managed session. For example, this may include pausing the managed session, terminating the managed session, generating a prompt for authentication in connection with the managed session, or the like. In some embodiments, the security action may be an action associated with identity 112 or target resource 120. For example, the security action may include managing a secret associated with identity 112 or target resource 120 (e.g., rotation of a password; key; encryption scheme, etc.), changing a policy associated with identity 112 or target resource 120 (e.g., changing a role of identity 112, disabling identity 112 in a directory, changing a permission set, etc.), or various other security measures.

In some embodiments, the security action may be performed based on whether semantic data 322 indicates identity 112 deviated from an intended network action. For example, output 332 may indicate an action identity 112 was likely intending to perform based on semantic data 322 and context data 324. Alternatively or additionally, process 300A may further include receiving from identity 112 an intended network action. For example, this may include prompting identity 112 to provide an indication of the intended network action. If the actual activity deviates from the intended network action, a security action may be performed.

In some embodiments, various additional trained models may be implemented in association with the session monitoring techniques disclosed herein. FIG. 3B is a block diagram showing another example process 300B for dynamically reviewing managed session activity, consistent with the disclosed embodiments. Process 300B may be the same as or similar to process 300A, but may include an additional trained model 340 for generating context data 324. As shown in FIG. 3B security server 130 may input some or all of semantic data 322 (or the session data from which semantic data 322 is derived) into trained model 340. Accordingly, trained model 340 may have been pre-trained on data associated with the identity 112. For example, trained model 340 may implement at least one of semi-supervised learning, unsupervised learning, or reinforcement learning techniques. In some embodiments, trained model 340 may be configured to output a profile for identity 112 based on data stored in an identity database. In some embodiments, the output may further include data clustered from a plurality of data sources associated with identity 112. The data sources may include sources of “sensor” data associated with the network identity. These sensors may include each product and communication method utilized by the identity to connect to the network, including software agents and hardware proxies and gateways. Based on data accumulated from these data sources, a risk level and a risk threshold may be determined as part of the data clustering and profiling of a selected identity. In some embodiments, the accumulated data may include data gathered through managed sessions by other users and/or behavioral data accumulated across different activities over a period of time.

Consistent with some disclosed embodiments, trained model 340 may be an artificial neural network configured to generate context data. Various other machine learning algorithms may be used, including a logistic regression, a linear regression, a regression, a random forest, a K-Nearest Neighbor (KNN) model, a K-Means model, a decision tree, a cox proportional hazards regression model, a Naïve Bayes model, a Support Vector Machines (SVM) model, a gradient boosting algorithm, a deep learning model, or any other form of machine learning model or algorithm.

In some embodiments, output 332 may indicate whether a particular form of network activity occurred. For example, security server 130 may access a list of predefined suspicious network activities. Output 332 may indicate whether one or more of these predefined activities occurred. For example, a prompt may be input into trained model 330 asking whether one or more of the predefined suspicious network activities occurred, and output 332 may include an indication of whether or not they occurred. In some embodiments, one or more of the predefined suspicious network activities may be based on a previous output of trained model 330. For example, if trained model 330 identifies a security threat, security server 130 may add the identified security threat to a database and monitor for this form of activity in future sessions. A security action may be performed if output 332 indicates one of the predefined suspicious network activities has occurred.

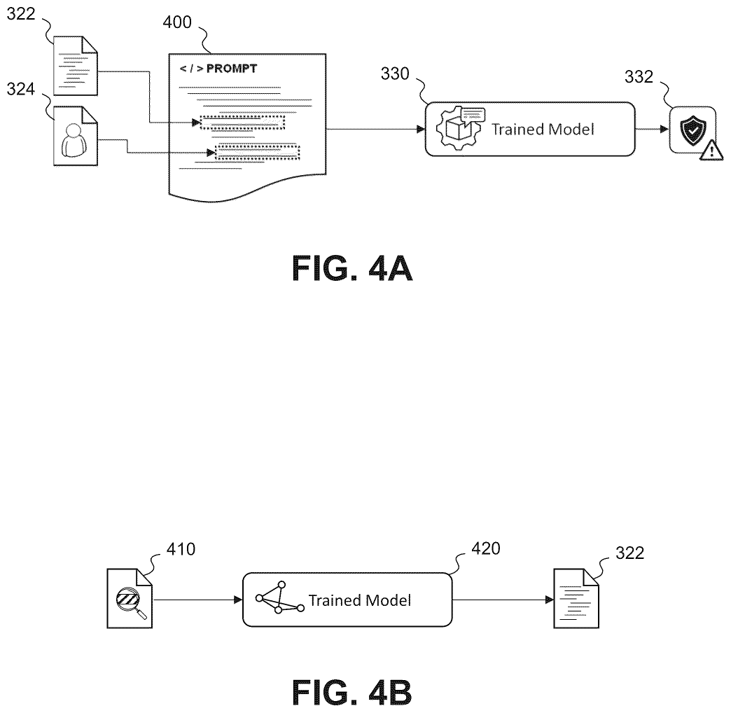

As described above, trained model 330 may include an LLM configured to generate output 332 in response to a text-based prompt. In some embodiments, process 300A (or 300B) may include generating a prompt to input into trained model 330. FIG. 4A is a block diagram showing an example process for generating a prompt 400 to input to trained model 330, consistent with the disclosed embodiments. In some embodiments, prompt 400 may be based on a prompt template, which may be used by security server 130 to generate output 332. Accordingly, security server 130 may input semantic data 322 and context data 324 into the template to generate prompt 400, as shown in FIG. 4A. In some embodiments, some or all of prompt 400 may be generated in a standardized format, such as a CSV format, a JSON format, or the like.

According to some embodiments, prompt 400 may be an open-ended text prompt. For example, prompt 400 may include instructions such as “You are given the following sequence of Linux commands: {commands}. As a knowledgeable Linux security analyst, methodically analyze the provided commands based on the following context: {context}. Critically assess the list for any commands or sequences of commands that may present a cybersecurity risk.” In this example, “[commands}” may represent semantic data 322 and “{context}” may represent context data 324. Based on prompt 400, trained model 330 may generate an output assessing a security risk. One of skill in the art would recognize various other instructions that may be added to prompt 400, such as limitations on how many risks to analyze, a threshold degree of confidence for risks to be reported, specific types of risks to analyze, a specific format for outputting the response (e.g., a JSON format, etc.), or the like.

As discussed above, reviewal process 320 may provide session data, which may be translated into semantic data 322 and provided to trained model 330. In some embodiments, an additional trained model may be used to extract semantic data 322 based on the session data. FIG. 4B is a block diagram showing an example process for generating semantic data using a trained model 420, consistent with the disclosed embodiments. In this example, security server 130 may identify session data 410 through reviewal process 320. Session data 410 may be input to trained model 420, which may output semantic data 322. Trained model 420 may be an artificial neural network configured to extract semantic data. Various other machine learning algorithms may be used, including a logistic regression, a linear regression, a regression, a random forest, a K-Nearest Neighbor (KNN) model, a K-Means model, a decision tree, a cox proportional hazards regression model, a Naïve Bayes model, a Support Vector Machines (SVM) model, a gradient boosting algorithm, a deep learning model, or any other form of machine learning model or algorithm.

In some embodiments, trained model 420 may be configured to determine a relevancy of one or more portions of session data 410. For example, trained model 420 may receive session data 410 as an input and may output a subset of session data 410 determined to be relevant, which may then be translated to semantic data 322. For example, the subset of session data 410 may include a selected frame from a video, a selected text from a frame, a selected set of commands from a command log, or the like. Accordingly, trained model 420 may be trained using a training set of session data (e.g., images, videos, commands, keystrokes, etc.), which may be labeled to indicate which portions thereof are relevant to security server 130. The training data may be input into a training algorithm and, as a result of the training process, trained model 420 may be configured to identify relevant portions of session data 410.

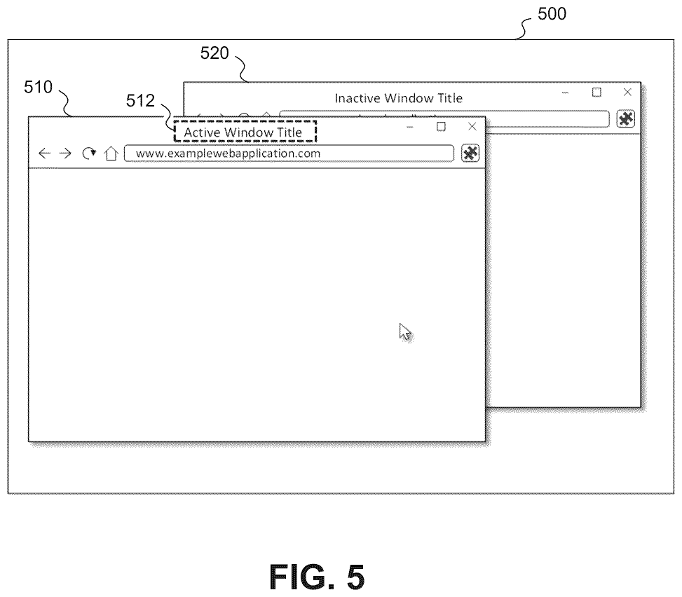

In some embodiments, session data 410 may include various images captured during managed session 310. For example, the images may include screenshots or frames of a video captured on computing device 110. Trained model 420 or various other image recognition algorithms may be configured to extract semantic data 322 from these images. FIG. 5 is an illustration of an example image 500 from which semantic information may be extracted, consistent with the disclosed embodiments. In this example, image 500 may be a screenshot or a frame of a video captured during managed session 310. For example, image 500 may be a screenshot captured on computing device 110 during managed session 310. In this example, computing device 110 may have multiple application windows open, such as application windows 510 and 520. In some embodiments, image 500 may represent session data and various information from an application window may be extracted as semantic data 322. For example, semantic data 322 may include a title of an application window, such as active window title 512. While a window title is used for purposes of illustration, various other aspects of an open application may be used as semantic data 322, such as a tab name, a filename, a username, a window position, information entered into an application window (e.g., a text input, etc.), a checkbox (e.g., indicating configuration changes), lists or ordered elements (e.g., order elements that may impact applications states), or any other information that may be displayed in image 500.

As discussed above, in some embodiments, a subset of session data may be identified and included in semantic data 322. In this example, the subset may include information associated with an active window. Accordingly, security server 130 may be configured to distinguish active window 510 from inactive window 520 as the title of inactive window 520 may be less relevant for monitoring an activity of identity 112. In some embodiments, active window 510 may be identified using a trained model, such as trained model 420. Accordingly, trained model 420 may be trained to identify active window 510 within image 500 and/or to extract active window title 512 from the image. For example, trained model 420 may have been trained using a training set of images containing representations of one or more application windows, which may be labeled to indicate an active window and/or active window title. In some embodiments, the training images may include at least some generated images to increase the training sample size. For example, it may be difficult or impossible to find datasets of images that are tagged with window titles or other properties. To address this, a training data set may be generated, at least in part, by labeling an initial set of images and generating additional labeled images based on the initial images. For example, this may include, converting labeled images to black and white, rotating labeled images, changing a color schema of labeled images, or various other manipulations. In some embodiments the training images may be labeled with additional information such as showing multiple open windows, a title that is partially covered, not containing any title, including a blurred title, or the like. The training images may be input into a machine learning algorithm and, as a result, trained model 420 may be trained to identify active window 510. Various other image recognition algorithms or techniques may equally be used for extracting semantic data 322 from image 500. Alternatively or additionally, in embodiments where session data is input directly into trained model 330, image 500 may be input directly into trained model 330.

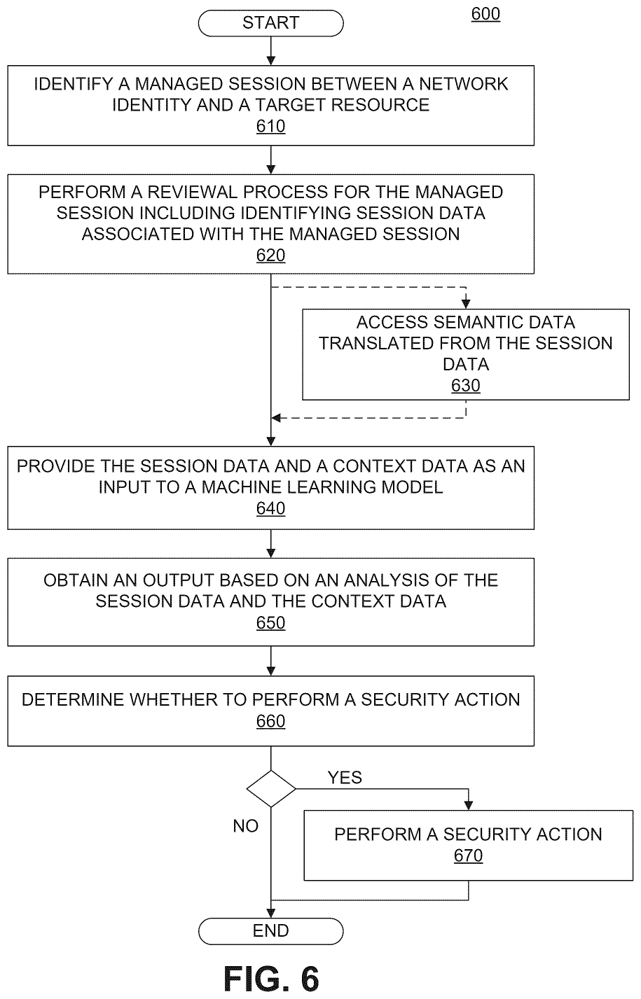

FIG. 6 is a flowchart showing an example process 600 for dynamically reviewing managed session activity using machine learning models, consistent with the disclosed embodiments. Process 600 may be performed by at least one processor of a server, such as processor 210, as described above. Alternatively or additionally, some or all of process 600 may be performed by at least one processor of a computing device, such as processor 250. It is to be understood that throughout the present disclosure, the term “processor” is used as a shorthand for “at least one processor.” In other words, a processor may include one or more structures that perform logic operations whether such structures are collocated, connected, or dispersed. In some embodiments, a non-transitory computer readable medium may contain instructions that when executed by a processor cause the processor to perform process 600. Further, process 600 is not necessarily limited to the steps shown in FIG. 6, and any steps or processes of the various embodiments described throughout the present disclosure may also be included in process 600, including those described above with respect to, for example, FIGS. 3A, 3B, 4A, 4B, and 5.

In step 610, process 600 may include identifying a managed session between a network identity and a target resource. For example, step 610 may include identifying managed session 310 between computing device 110 and target resource 120, as described above. It is to be understood, however, that process 600 is not limited to any particular form of managed session or types of entities involved in the managed session.

In step 620, process 600 may include performing a reviewal process for the managed session. For example, step 620 may include performing reviewal process 320, as described above. Consistent with the disclosed embodiments, the reviewal process may include identifying session data associated with the managed session. In some embodiments, the reviewal process may include intercepting at least a portion of the session data during the managed session. For example, security server 130 may be configured to intercept traffic between computing device 110 and target resource 120 to identify the session data. Alternatively or additionally, the reviewal may performed by an agent running at a machine used by the identity. For example, the reviewal process may be performed by an agent running on computing device 110. The agent may include, for example, an endpoint privilege management service, a browser extension, a browser application, or various other software components that may execute on computing device 110.

In some embodiments, the session data is translatable to semantic data. For example, session data 410 may be translatable to semantic data 322. As one example, the session data may include a video of the managed session and the semantic data may include text extracted from the video.

In embodiments where session data is translated to semantic data prior to inputting it into a trained model, process 600 may include a step 630 of accessing the semantic data translated from the session data. For example, step 630 may include accessing semantic data 322, as described above. In some embodiments, accessing the semantic data may include translating the session data to generate the semantic data. For example, security server 130 may be configured to translate the session data as part of process 600. Alternatively or additionally, security server 130 may access the translated data, which may have been translated by another resource. In embodiments where session data is input directly into trained model 330, step 630 may not be required.

According to some embodiments, the session data may be preprocessed to identify a relevancy of at least a portion of the session data. For example, this may include preprocessing semantic data 322 or session data 410 to identify a relevant portion of data. In some embodiments, the preprocessing may include providing the session data to at least one additional machine learning model pretrained to determine the relevancy of session data. For example, this may include providing session data 410 to trained model 420, as described above. In some embodiments, the at least one additional machine learning model may be pretrained to determine the relevancy of session data based on an active window associated with the managed session. For example, trained model 420 may be trained to identify active window title 512, or various other information associated with active window 510. Through the preprocessing, an output of the at least one additional machine learning model may include a selected subset of the session data determined to be relevant.

In step 640, process 600 may include providing the session data (or semantic data) and a context data as an input to at least one machine learning model. For example, step 640 may include inputting semantic data 322 or (session data 410) and context data 324 into trained model 330, as described above. In some embodiments, the at least one machine learning model may include at least one large language model, as discussed above. According to some embodiments, providing the semantic data and the context data as an input to at least one machine learning model may include generating a prompt for the large language model. For example, step 640 may include generating prompt 410, as described above, which may include the session data and the context data.

The context data may include data clustered from a plurality of data sources associated with the network identity. For example, data from the plurality of data sources may be stored in a database, such as database 132, and step 640 may include accessing context data 324 from database 132. The plurality of data sources may include a wide variety of data source types from which information about an identity may be accessed. For example the data sources may include computing device 110, social media accounts associated with identity 112, a memory location including historical information associated with identity 112, or the like. According to some embodiments, the context data may include historical managed session data. In other words, the context data may include session data, semantic data, or other data associated with a previous managed session. In some embodiments, the historical managed session data may be associated with the identity (e.g., identity 112). Alternatively or additionally, the historical managed session data may be associated with one or more identities determined to be related or similar to the identity. For example, the one or more identities may share at least one characteristic with identity 112. Accordingly, the historical managed session data may provide context as to how identity 112 or similar identities normally behave. In some embodiments, the context data may include synthetic managed session data, which may include at least some information that has been generated. As another example, the context data may include organization data. For example, this may include a group role, a department, a position (e.g., manager), a start date, or other organizational information for identity 112. In some embodiments, the context data may include a geographical location, access permissions to one or more assets, historical access to assets, or the like.

As another example, the context data may include metadata associated with the identity. For example, this may include an email address, an IP address, a physical location, timestamp information, a username or other credential, or the like. In some embodiments, the context data may include sensor data associated with the identity. The sensor data may include any information associated with identity 112 that may be recorded, such as a geolocation, biometric data, or the like.

In some embodiments, step 640 may include receiving the context data as an output of an additional machine learning model. For example, step 640 may include receiving context data 324 as an output of trained model 340, as described above. The additional machine learning model may have been pre-trained on data associated with the network identity, as discussed in further detail above.

In step 650, process 600 may include obtaining an output from the at least one machine learning model. For example, step 650 may include receiving output 332. As described above, the output may be based on an analysis of the session data and the context data. In some embodiments, the output from the at least one machine learning model may include at least one indication of malicious intent by the network identity that is not associated with a rule-based security policy. In other words, the output may indicate malicious activity by identity 112, even where the activity itself does not violate a rule of an established rule-based security policy. For example, it may be difficult or impossible to capture the nearly infinite combinations of activities and context information that indicate a potential security threat. For example, accessing cloud credentials from a local machine may be commonplace and may not indicate a security risk. But the same access from a local machine may be suspicious, for example, if the developer is on a long vacation or if the developer moved to another department, which may be indicated through context data. Accordingly, process 600 may detect activity that does not violate any policies, but nonetheless appears to be malicious based on a context of the activity.

In step 660, process 600 may include determining, based on the output, whether to perform a security action associated with the managed session. The security action may include any action taken in response to an indication from output 332. For example, the security action may include generating an alert for the managed session or generating a report for the managed session. As another example, the security action may include at least one of pausing or terminating the managed session. The security action may include various other security measures, such as requiring an authentication associated with the managed session, managing a secret associated with at least one of the network identity or the target resource, managing a policy associated with at least one of the network identity or the target resource, or the like. In some embodiments, process 600 may be performed based on recorded session activity, as discussed above. Accordingly, the determination whether to perform the security action may occur during a current timeframe and the session data may include session data recorded during a previous timeframe (i.e., prior to the current timeframe).

In some embodiments, the determination whether to perform the security action may be based, at least in part, on an intended action of the identity. For example, step 660 may include determining, based on the output from the at least one machine learning model, an intended network action associated with the network identity. For example, the intended network action may include a command, a behavior, or other activities by the identity. The determination whether to perform the security action may be based on the intended activity. Accordingly, process 600 may allow security actions to be implemented based on an intended activity of an identity, possibly before or without the intended activity having occurred.

As another example, step 660 may include receiving from the network identity an indication of an intended network action. For example, identity 112 may indicate to security server 130 an activity it is attempting to perform. Step 660 may include determining, based on the output from the at least one machine learning model, whether the monitored session deviates from the intended network action. For example, analyzing semantic data 322 (or session data 410) and context data 324 may indicate identity 112 has deviated from an action identity 112 indicated it intended to perform. Accordingly, the security action may be performed when the monitored session deviates from the intended network action.

In some embodiments, process 600 may be used to detect specific malicious activity. For example, security server 130 may store or have access to a plurality of predefined suspicious network activities. Step 660 may include determining, based on the output from the at least one machine learning model, whether the monitored session includes an activity from the plurality of predefined suspicious network activities. Accordingly, the security action may be performed when the monitored session includes the activity from the set of suspicious network activities. In some embodiments, the plurality of predefined suspicious network activities may be determined based on a previous output from the at least one machine learning model. For example, security server 130 may keep a record of identified suspicious activities and may continue to identify future activities matching the suspicious activities.

As discussed above, trained model 330 may be configured to receive feedback from identity 112. For example, determining whether to perform the security action associated with the managed session is further based on feedback from at least one of the network identity or the target resource. The feedback may include, for example, data provided by the network identity, data associated with an action performed on the target resource by the network identity, a previous determination of whether to perform the security action, or the content of the security action.

It is to be understood that the disclosed embodiments are not necessarily limited in their application to the details of construction and the arrangement of the components and/or methods set forth in the following description and/or illustrated in the drawings and/or the examples. The disclosed embodiments are capable of variations, or of being practiced or carried out in various ways.

The disclosed embodiments may be implemented in a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowcharts and block diagrams in the Figures illustrate the architecture, functionality, and operation of possible implementations of systems, methods and computer program products according to various embodiments of the present invention. In this regard, each block in the flowcharts or block diagrams may represent a software program, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant virtualization platforms, virtualization platform environments, trusted cloud platform resources, cloud-based assets, protocols, communication networks, security tokens and authentication credentials, and code types will be developed, and the scope of these terms is intended to include all such new technologies a priori.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1. A non-transitory computer readable medium including instructions that, when executed by at least one processor, cause the at least one processor to perform operations for dynamically reviewing managed session activity using machine learning models, the operations comprising:
identifying a recorded managed session between a network identity and a privileged target resource, wherein the recorded managed session includes access by the network identity using a Remote Desktop Protocol (RDP) or a Secure Shell Protocol (SSH) to perform at least one privileged operation at the privileged target resource;
performing a reviewal process for the recorded managed session, the reviewal process comprising identifying session data associated with the recorded managed session, wherein the session data reflects one or more actions performed by the network identity associated with the at least one privileged operation;
accessing context data clustered from a plurality of data sources associated with the network identity, the context data being associated with at least one previous managed session associated with the network identity;
providing the session data and context data as an input to at least one large language model;
obtaining an output from the at least one large language model, the output being based on an analysis of the session data and the context data; and
determining, based on the output, whether to perform a security action associated with the recorded managed session.

2. The non-transitory computer readable medium of claim 1, wherein the output from the at least one machine learning model includes at least one indication of malicious intent by the network identity that is not associated with a rule-based security policy.

3. The non-transitory computer readable medium of claim 1, wherein the operations further include receiving the context data as an output of an additional machine learning model, the additional machine learning model having been pre-trained on data associated with the network identity.

4. The non-transitory computer readable medium of claim 1, wherein the context data further includes at least one of: metadata associated with the network identity, sensor data associated with the network identity or synthetic managed session data.

5. The non-transitory computer readable medium of claim 1, wherein the context data further includes historical managed session data associated with identities determined to be related or similar to the network identity.

6. The non-transitory computer readable medium of claim 1, wherein the reviewal process includes intercepting at least a portion of the session data during the recorded managed session.

7. The non-transitory computer readable medium of claim 1, wherein the session data is preprocessed to identify a relevancy of at least a portion of the session data.

8. The non-transitory computer readable medium of claim 7, wherein the preprocessing includes providing the session data to at least one additional machine learning model having been pretrained to determine the relevancy of session data.

9. The non-transitory computer readable medium of claim 8, wherein the at least one additional machine learning model is pretrained to determine the relevancy of session data based on an active window associated with the recorded managed session.

10. The non-transitory computer readable medium of claim 8, wherein an output of the at least one additional machine learning model includes a selected subset of the session data.

11. The non-transitory computer readable medium of claim 1, wherein the determination whether to perform the security action occurs during a current timeframe and the session data includes session data recorded during a previous timeframe prior to the current timeframe.

12. The non-transitory computer readable medium of claim 1, wherein the reviewal is performed by an agent running at a machine used by the network identity.

13. The non-transitory computer readable medium of claim 1, wherein providing the session data as an input to at least one machine learning model includes translating the session data to semantic data.

14. The non-transitory computer readable medium of claim 13, wherein the session data includes a video of the recorded managed session and wherein the semantic data includes text extracted from the video.

15. The non-transitory computer readable medium of claim 1, wherein determining whether to perform the security action associated with the recorded managed session is further based on feedback from at least one of: the network identity or the target resource.

16. The non-transitory computer readable medium of claim 15, wherein the feedback includes at least one of: data provided by the network identity, data associated with an action performed on the target resource by the network identity, a previous determination of whether to perform the security action, or the content of the security action.

17. The non-transitory computer readable medium of claim 1, wherein providing the session data and the context data as an input to at least one machine learning model includes generating a prompt for the large language model, the prompt including the session data and the context data.

18. The non-transitory computer readable medium of claim 1, wherein the security action includes at least one of: generating an alert for the recorded managed session or generating a report for the recorded managed session.

19. The non-transitory computer readable medium of claim 1, wherein the security action includes at least one of: pausing or terminating the recorded managed session.

20. The non-transitory computer readable medium of claim 1, wherein the security action includes at least one of: requiring an authentication associated with the recorded managed session, managing a secret associated with at least one of the network identity or the target resource, or managing a policy associated with at least one of the network identity or the target resource.

21. A computer-implemented method for dynamically monitoring network session activity using trained large language models, the method comprising:
identifying a recorded managed session between a network identity and a privileged target resource, wherein the recorded managed session includes access by the network identity using a Remote Desktop Protocol (RDP) or a Secure Shell Protocol (SSH) to perform at least one privileged operation at the privileged target resource;
performing a reviewal process for the recorded managed session, the reviewal process comprising identifying session data associated with the recorded managed session, wherein the session data reflects one or more actions performed by the network identity associated with the at least one privileged operation;
accessing context data clustered from a plurality of data sources associated with the network identity, the context data being associated with at least one previous managed session associated with the network identity;
providing the session data and context data as an input to at least one large language model;
obtaining an output from the at least one large language model, the output being based on an analysis of the session data and the context data; and
determining, based on the output, whether to perform a security action associated with the recorded managed session.

22. The computer-implemented method of claim 21, further comprising determining, based on the output from the at least one machine learning model, an intended network action associated with the network identity.

23. The computer-implemented method of claim 22, wherein the intended network action comprises at least one of: a command or a behavior.

24. The computer-implemented method of claim 21, further comprising receiving from the network identity an indication of an intended network action.

25. The computer-implemented method of claim 24, further comprising determining, based on the output from the at least one machine learning model, whether the monitored session deviates from the intended network action.

26. The computer-implemented method of claim 25, further comprising performing the security action when the monitored session deviates from the intended network action.

27. The computer-implemented method of claim 21, further comprising determining, based on the output from the at least one machine learning model, whether the monitored session includes an activity from a plurality of predefined suspicious network activities.

28. The computer-implemented method of claim 27, wherein the plurality of predefined suspicious network activities are determined based on at least one previous output from the at least one machine learning model.

29. The computer-implemented method of claim 27, further comprising performing the security action when the monitored session includes the activity from the set of suspicious network activities.

30. The non-transitory computer readable medium of claim 1, wherein the plurality of data sources are different from the target resource, and wherein the context data reflects a behavior of the network identity in association with the plurality of data sources.
